(19) United States
(12) Patent Application Publication
(10) Pub. No.: US 2008/0046266 A1
(43) Pub. Date: Feb. 21, 2008

(54) Service level agreement management

(76) Inventors: Chandu Gudipalley, Mableton, GA (US); Chad Monden, Atlanta, GA (US); John Abbott, Boca Raton, FL (US); Shahram Amid, Atlanta, GA (US); Richard Banke, Seabrook, TX (US)

Correspondence Address: MERCHANT & GOULD BELLSOUTH CORPORATION, P.O. BOX 2903, MINNEAPOLIS, MN, 55402, US

(21) Appl. No.: 11/784,301

(22) Filed: Apr. 6, 2007

Related U.S. Application Data
(60) Provisional application No. 60/819,508, filed on Jul. 7, 2006.

(51) Int. Cl. G06F 15/173; G06Q 10/00; H04L 12/26

(52) U.S. Cl. 705/1; 370/252; 709/223

(57) ABSTRACT

Consistent with embodiments of the present invention, systems and methods are disclosed for providing service level agreement management. The method may include collecting performance data on a data network and collecting service information including at least one rule. The rule may include a service level agreement rule and a contract rule. The method may further include correlating the performance data and the service information and determining a violation of the at least one rule by the data network based on the collected performance data and the at least one rule. The method may further include collecting billing charges or monthly recurring charges corresponding to a service. The method may further include determining the penalties or charges to be given to a service and to a customer according to at least one rule in the event of a violation of the at least one service level agreement rule and a contract rule.

### RELATED APPLICATION

Under provisions of 35 U.S.C. § 119 (e), the Applicants claim the benefit of U.S. provisional application No. 60/819,508, entitled “Service Level Agreement Management System and Method”, filed Jul. 7, 2006, which is incorporated herein by reference in its entirety.

### BACKGROUND

A Service Level Agreement (SLA) is a formal negotiated agreement between a service provider and a customer that formalizes a business relationship between the two parties. The SLA specifies the terms and conditions associated with the delivery of a product or service with a guaranteed Quality of Service (QoS) and any financial guarantees associated with the delivery of the service. Quality of Service is defined by International Telecommunications Union (ITU-T) as “the collective effect of service performances, which determine the degree of satisfaction of a user of the service. The Qualify of Service is characterized by the combined aspects of service support performance, service operability performance, service integrity and other factors specific to each service.

The SLA may include the QoS metrics associated with the delivery of a product or service, thresholds that specify upper or lower bounds of the metrics values deemed acceptable from a service performance stand point as well as credits and penalties associated when the service performance falls below the established thresholds

In the telecommunications world, the product or service that is offered by the service provider is the network communications such as a VPN Service or a internet access service. The performance of the network is described by QoS metrics such as Availability, latency, packet loss, jitter which are also typically termed as Key Performance Indicators (KPIs). These metrics could be typically categorized as Network Performance Metrics or Network KPIs. In addition, the SLAs also cover business process related activities such as provisioning of the network service, installation time of the service and response time to troubles which is expressed as Mean time to repair (MTTR). These would be termed as business process metrics or Business process KPIs. SLAs would also cover areas such as responsive support or customer service such as trouble ticket acknowledgement times, billing accuracy and dispute resolution durations, disaster recovery operations and so on.

The SLA document is the general basis for managing the execution of the contract between service providers and customers. Service providers are held accountable to ensure that the performance of the service or product is in compliance with the SLA agreement. As such, customers demand proof or verification of SLA compliance. As a result, service providers perform extensive data gathering on various metrics and generate reports that demonstrate SLA compliance. The SLA reports are also used by the service provider to identify trouble spots and improve service performance by prioritizing resources in a cost effective manner.

Service Level Agreement Management is a discipline that deals with the management of all the process related to SLA, from the development of the SLA contract, implementation of the SLA, verification or assessment of the SLA and the management of customer the verification and assessment of the SLA contract to improvement of the business and operational processes involved in the delivery of the service.

### SUMMARY OF THE INVENTION

Consistent with embodiments of the present invention, systems and methods are disclosed for service level agreement management. The method may include collecting performance data on a data network and collecting service information including at least one rule. The rule may include a service level agreement rule and a contract rule. The method may further include correlating the performance data and the service information and determining a violation of a rule by the data network based on the collected performance data and the rule.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a service level agreement management system consistent with embodiments of the present invention;

FIG. 2 is a block diagram of a communication system consistent with embodiments of the present invention;

FIG. 3 is a block diagram of a performance processor;

FIG. 4 is flow chart of a method for providing service level agreement management; and

FIG. 5 is a flow chart of a subroutine that may be used in the method of FIG. 4 for collecting performance data on a data network.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention provide service level agreement management. For example, a service provider may have a customer where an agreement exists between the two stating that the service provider will provide a certain level of service. This agreement is typically termed a service level agreement (SLA). The service level agreement may list what products and services are provided. In addition, the SLA may list what performance may be associated with the products and services, minimum thresholds associated with the products and services, and credits and penalties associated with failure to provide the products or services at the agreed upon performance level.

Furthermore, the SLA may contain other rules which govern the SLA. For example, one rule may state that a particular service may only be available for certain time frames such as business hours. Other rules may state that the service provide will not incur a penalty for a failure due to force majuere.

In order to support SLAs, service providers take network measurements at periodic intervals and from different measurement points, for example, CPE to the provider edge (PE) and within the provider core, from a PE to every other PE. To do this, service providers install measurement probes at different points in the network that continuously take measurements of the network performance. Service providers may measure network performance across access lines of any type within or without a VRF typically associated with a Virtual Private Network. This process is also agnostic regarding whether the CPE is within or outside the territory serviced or managed by the service provider. Conventional processes cannot function within a VRF since the VRF is a private network. In the past, to address this problem with conventional processes, dedicated equipment was needed for each VRF. If a provider supports thousands of VRF's, this solution would be cost prohibitive. In addition, detecting network connectivity failures such as inability to transmit data from CPE to the PE or within the service provider core from a PE to any other PE, is also cost prohibitive with conventional processes. Accordingly, the MVPN is provided, and in conjunction with a performance software module and service provider probe processes, performance measurements can be supported from one or more devices to any CPE in any CVPN (i.e. VRF). The MVPN can perform the following functions: i) measure network performance (such as but not limited to delay round trip, delay one way, jitter round trip, jitter one way, packet loss round trip, packet loss one way, and packets out of sequence) across any layer 2 access method (e.g. Frame Relay, Ethernet, ATM); ii) measure network performance within a customer VRF from a single or more than one device that is not directly a part of the customer VRF; iii) measure network performance either within the service provider territory or across another carriers network using an inter-provider VPN model; iv) measure end-to-end network performance from CPE to the PE, within the core from a PE to every other PE, and across another access line without needing to run a specific test from a customer's first CPE to a customer's second CPE; and v) detect end-to-end network connectivity failures that for example, include, from CPE to the service provider edge (PE) of the core and within the core from one PE of the core to every other PE in the core.

Consistent with embodiments of the invention a system for providing service level agreement management comprises a memory storage maintaining metrics outlining the details of the SLA and a processing unit coupled to the memory storage. The processing unit may be operative to collect network performance measurement data. In addition, the processing unit may be operative to collect service information comprising at least one of a customer, a product, and at least one rule. The at least one rule includes at least one of a service level agreement rule and a contract rule. Additionally, the processing unit may be operative to correlate the performance data and he service information. The at least one rule and the service information may be correlated into a service level template. The service level template may provide an association of the customer, the product, and the at least one rule. Furthermore, the processing unit may be operative to determine a violation of at least one rule by the data network. The violation may be based on the collected performance data and the at least one rule.

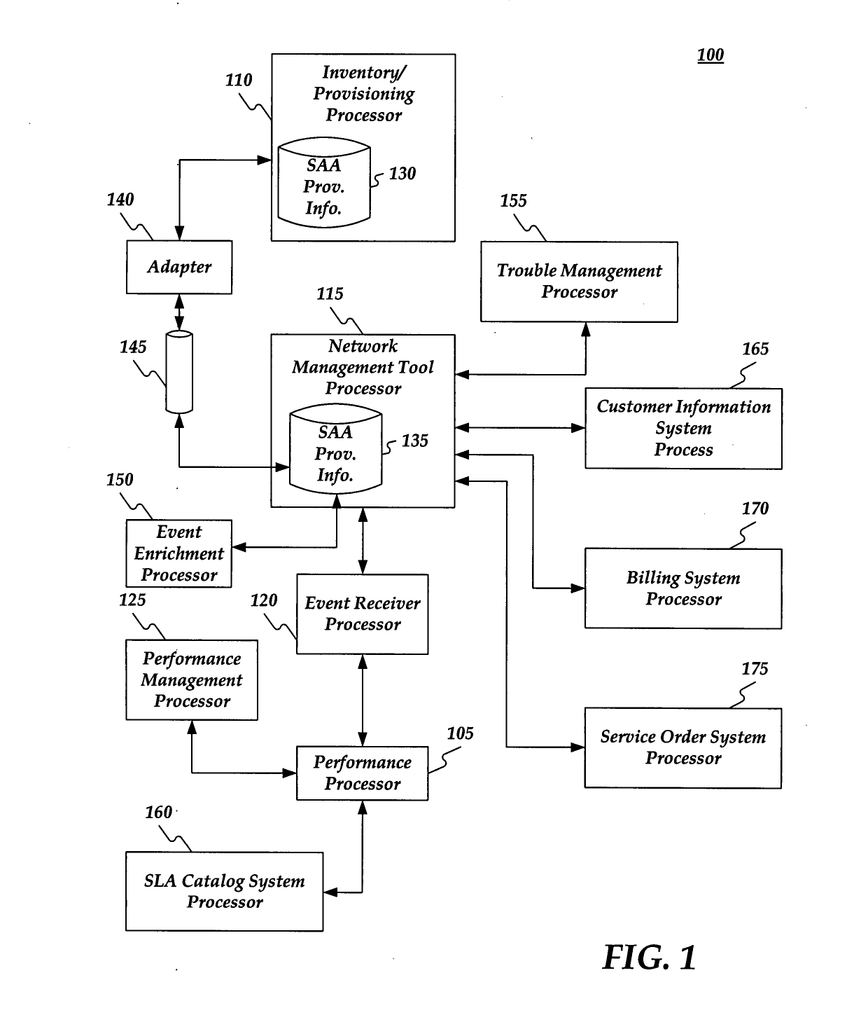

Consistent with embodiments of the present invention, the aforementioned memory, processing unit, and other components may be implemented in a service level agreement management system, such as service level agreement management system 100 of FIG. 1. Any suitable combination of hardware, software and/or firmware may be used to implement the memory, processing unit, or other components. For example, the memory, processing unit, or other components may be implemented with any one or more of a performance measurement processor 105, an inventory/provisioning processor 110, a network management tool processor 115, an event receiver processor 120, and a trouble management processor 155 in combination with system 100. Still consistent with embodiments of the present invention, other systems and processors may comprise the aforementioned memory, processing unit, or other components.

FIG. 1 illustrates system 100 including, for example, operations support systems (OSS) components involved in monitoring, data collection and analysis, and reporting on SLAs offered to customers by the service provider. Consistent with embodiments of the invention, service level agreement management may be dependent on data collection from the network measurement probes and processing of the data by a number of these OSS. As illustrated FIG. 1, system 100 may include OSS comprising a performance management processor 125 configured for network performance data collection and reporting. Performance management processor 125 may use performance management software available from INFOVISTA of Herndon, Va. Furthermore network management tool processor 115 may be configured for collecting outage events generated by SAA and network devices. Network management tool processor 115 may utilize NETCOOL network management tools available from MICROMUSE INC. of San Francisco, Calif. Moreover, trouble management processor 110 may be configured for trouble ticket management.

Consistent with embodiments of the present invention, performance processor 105 may provide network performance measurement data from, for example, SAA measurement probes from Cisco may be utilized by performance processor 105. The network performance statistical data may then be collected and aggregated in near-real-time by performance management processor 125 for subsequent performance level reporting. Performance management processor 125 also collects performance data from network devices that include routers, switches and other network elements, for example, network interfaces. When the network performance data falls below a specific threshold, performance management processor 125 may send notification to event receiver processor 120 of the outage notification system 100.

The network measurement data from, for example, SAAs may also include outage information such as service performance degradation and network connectivity failures. These outages may occur when i) a device or interface on a device has failed to operate correctly or ii) excessive network congestion due to network traffic overload that prevents any new data from being sent from one point in the network. For example, a customer premises equipment (CPE) to another point in the network, or from a PE to another PE within the service provider core. Performance measurement processor 125 may then generate service failure events (e.g. traps) on service level threshold violations (network service performance degradations) and on network connectivity loss (e.g. inability to transmit data from one end point of the network to another point of the network). These notification events may be sent to event receiver processor 120 of outage notification system 100.

Performance measurement processor 105 may send service failure events (SAA traps) to outage notification system 100. More specifically, performance measurement process 105 may send SAA traps to the event receiver processor 120. Event receiver processor 120 may perform some computations that may extract relevant information from the traps and may send the processed information to the network management tool processor 115. Network management tool processor 115 may then correlate the service failure events from the SAAs with other service failure events. The SAA topology information may be maintained in a first SAA database 130 located on inventory/provisioning processor 110. The information from first SAA database 130 may then be retrieved and cached in network management tool processor 115 run-time memory 135 through adapter 140 and message bus system 145.

For example, events corresponding to the network performance degradation may be generated by the performance management processor 125 to generate a “root cause” event that may help ensure a quick identification and resolution of the problem. Based on the root-cause event, a single trouble ticket may be generated by trouble management processor 155 with information (e.g. the type of the service failure event the SAA detected, the service failure event, the VPNs that may be affected by the failure and the customers that were impacted by the failure). This information may then be used for subsequent trouble management processes that may include troubleshooting and resolving the problem. Additionally, SLA analysis may then be performed periodically (e.g. every month) on the network performance data collected by performance management processor 125 and from the trouble ticket information in trouble management processor 155. The SLA analysis process correlates the network performance data with other operational and service data such as trouble ticket information, provisioning information, customer information and service information. Once the data is correlated, the SLA analysis process applies various rules described in the SLA contract, performs computation to determine the service level metrics or KPIs, determines if there are any SLA violations by comparing the computed KPIs to the threshold values stated in the SLA contract. In the event of an SLA violation, the SLA Analysis process then computes the SLA credits (penalties) by applying various rules specified in the SLA contract. Consequently, SLA compliance reports may then be created that list the service or product, the SLA threshold, the computed SLA metric and the computed SLA credit. The SLA compliance reports are then and made available to the customers.

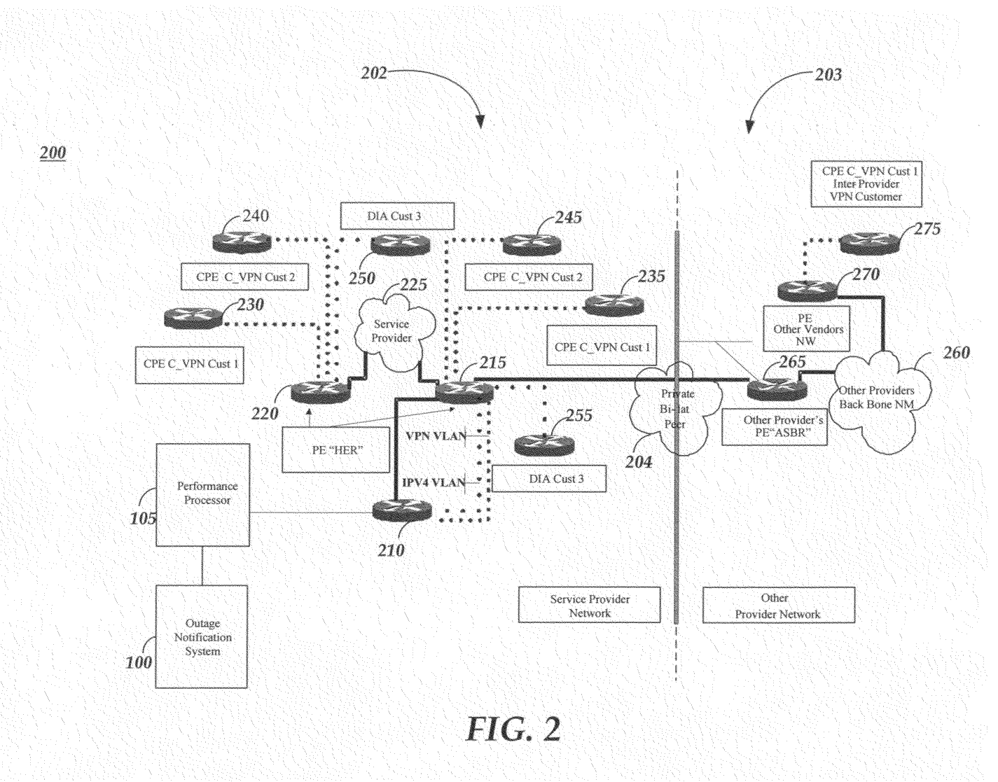

FIG. 2 illustrates system 200 which may include a service provider network 202 and other provider network 203 connected through a private bi-lateral peer 204. Service provider network 202 includes performance processor 105, a shadow router 210, a first provider edge (PE) router 215, a second PE router 220, and a service provider backbone 225.

Furthermore, CPE routers may be connected to service provider network 202. For example, service provider network 202 may include first customer CPEs 230 and 235, second customer CPEs 240 and 245, and third customer CPEs 250 and 255. First customer CPEs 230 and 235 may be associated as a first VPN and second customer CPEs 240 and 245 may be associated with a second VPN. Third customer CPEs 250 and 255 may not be associated with any VPN.

Other provider network 203 may include other provider backbone 260 and other provider PE's 265 and 270. In addition, other provider network 203 may include an additional first customer CPE 275. First customer CPEs 230, 235, and 275 may be associated as an “interprovider VPN,” which may include an interaction between service provider network 202 and other service provider network 203. An interprovider VPN may be used to support sharing VPN information across two or more carrier's networks. This may allow the service provider to support customer VPN networks (e.g. outside the service provider's franchise or region).

Shadow router 210 may be connected to first PE 215 via a single “Gig E” interface. This may allow shadow router 210 to use any operating system needed to support new functionality without posing a threat to the core network interior gateway protocol (IGP) or border gateway protocol (BGP) functions. The physical Gig E interface may have three virtual local areas networks (VLANs) associated with it. These three VLANS may be: i) one for IPV4 Internet traffic VLAN 230; ii) one for VPN-V4 traffic (VPN, VLAN 240); and iii) one for internal service provider traffic (VLAN 250).

First PE router 215 may be peered to a virtual router redundancy (VRR)-VPN router reflector so first PE router 215 may have information about all MVPN customer routes. These routes may be filtered to prevent unneeded customer specific routes from entering first PE router 215's routing table. Only /32 management loop back addresses assigned to customer CPEs may be allowed in first PE router 215's management VPN VRF table (e.g. 10.255.247.7./32). Other PE routers in service provider network 202 may communicate with shadow router 110 via service provider backbone 225.

First PE router 215 and second PE router 220 may provide performance measurement access to: i) first customer CPEs 230 and 235 via WAN interface addresses proximal to the CPE; ii) in region VPN customers (i.e. second customer CPEs 240 and 245); and iii) in and out-of-region customers using the MVPN (first customer CPEs 230 and 235 plus CPE 275). Shadow router 210 can reach the CPE devices via static routes. The CPEs may have management addresses that may be derived from, for example, the 10.160.0.0/14 range. The static routes may be summarized to control access to sensitive routes.

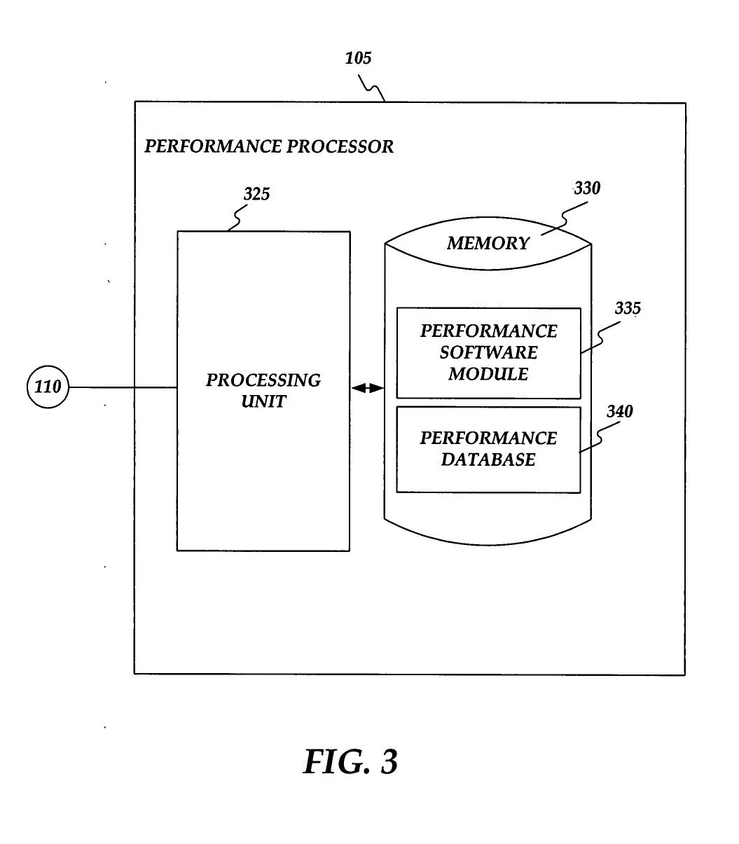

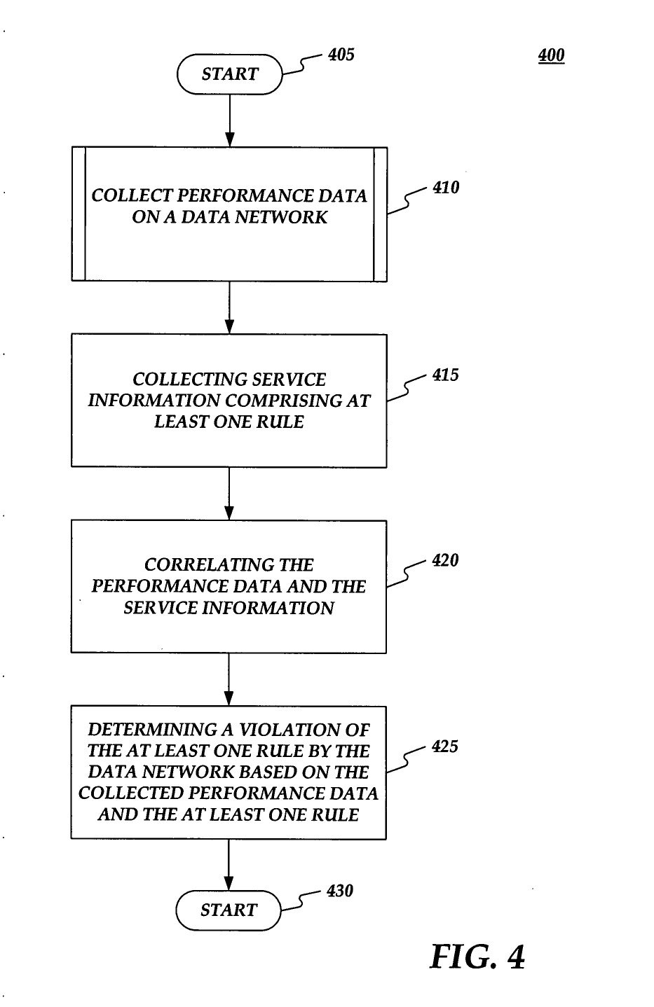

FIG. 3 shows performance processor 105 of FIG. 1 in more detail. As shown in FIG. 3, performance processor 105 includes a processing unit 325 and a memory 330. Memory 330 includes a performance software module 335 and a performance database 340. While executing on processing unit 325, performance software 335 performs processes for providing service level agreement management, including, for example, one or more of the stages of method 400 described below with respect to FIG. 4.

Performance processor 105 (“the processor”) included in system 100 may be implemented using a personal computer, network computer, mainframe, or other similar microcomputer-based workstation. The processor may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

In addition to utilizing a wire line communications system in system 100, a wireless communications system, or a combination of wire line and wireless may be utilized in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processor in the wireless environment can be any mobile terminal, such as the mobile terminals described above. Wireless data may include, but is not limited to, paging, text messaging, e-mail, Internet access and other specialized data applications specifically excluding or including voice transmission. For example, the processor may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802), a BLUETOOTH interface, another RF communication interface, and/or an optical interface.

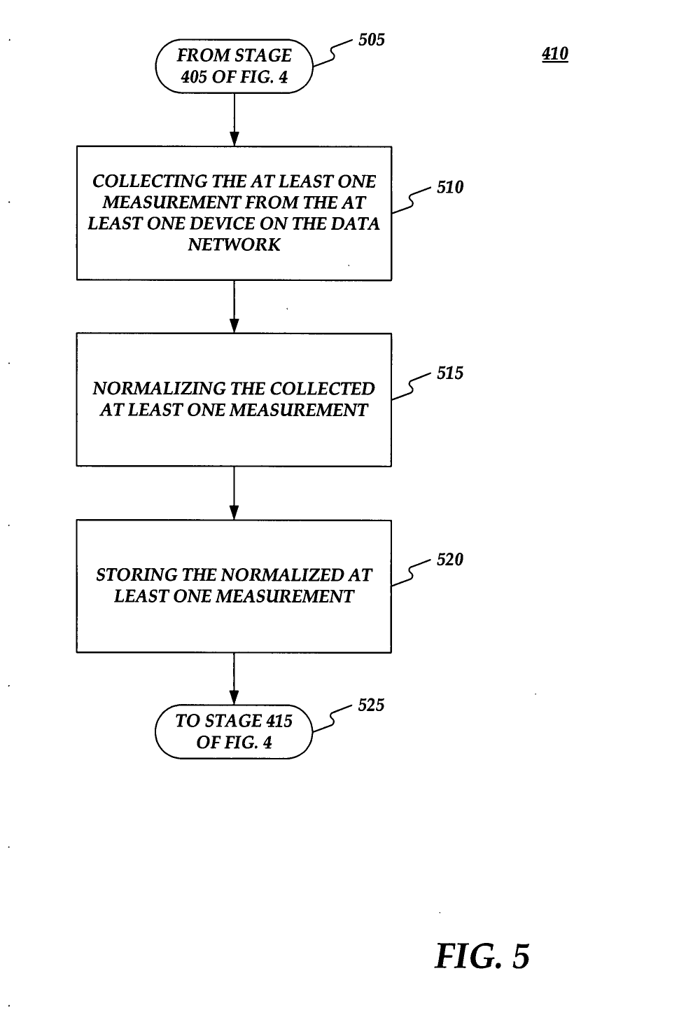

FIG. 4 is a flow chart setting forth the general stages involved in a method 300 consistent with an embodiment of the invention for providing service level agreement management. Method 400 may be implemented using performance processor 105 as described in more detail above with respect to FIG. 3. Ways to implement the stages of method 400 will be described in greater detail below. Method 400 may begin at starting block 405 and proceed to subroutine 410 where performance processor 105 may collect performance data on a data network (e.g. VPN 235, and 245, see FIG. 2) from network devices such as routers, switches and the interfaces on these devices. This data may include data such as bandwidth utilization on an interface, interface speed, ingress traffic and egress traffic. The performance process may also collect QoS Policer data on IP QoS enabled routers. QoS Policer is a process that is enabled on Router interfaces that monitors the traffic on the router interface and limits the ingress and egress traffic rates on the interface. This allows the service provider to limit bandwidth usage according to values stated in the SLA. If the traffic rate has exceeded the QoS thresholds, then the QoS Policer classifies the transmitted data packets as QoS conformed or QoS exceeded traffic. Conformed traffic is the traffic that was below the specified rate limit. Exceeded traffic is the traffic that exceeded the specified traffic rate limit. In addition, the performance processor may collect network performance data as measured by the network performance measurement probes (SAAs). The network performance data that is collected from the SAA probes may include metrics such as packet loss, latency and jitter per each traffic queue. Subroutine 410 will be described in greater detail with respect to FIG. 5 below.

From subroutine 410, where performance processor 105 collects performance data on the data network, method 400 may advance to state 412 where performance processor 105 may collect other operational and process information. The operational and process information may include at least one rule. The at least one rule may include one or both of a service level agreement rule and a contract rule. For example, collecting the operational information may include collecting operational information from a system. The system may include a trouble management processor 155, a service order system 175 and a service provisioning system 176.

From subroutine 412, where performance processor 105 collects operational and process data on the data network, method 400 may advance to state 413 where performance processor 105 may bill information. The billing information may include at least one rule. The at least one rule may include one or both of a service level agreement rule and a contract rule. For example, collecting the billing information may include collecting billing information from a system. The system may include a billing system processor 170.

From subroutine 410, where performance processor 105 collects performance data on the data network, method 400 may advance to stage 415 where performance processor 105 may collect service information. The service information may include at least one rule. The at least one rule may include one or both of a service level agreement rule and a contract rule. For example, collecting the service information may include collecting the service information from a system. The system may include a service level agreement catalog system 160, a customer information system 165, a billing system 170, and a service order system 175 and a service provisioning system 176.

From stage 415 where performance processor 105 may collect customer and service information, method 400 may advance to stage 420 where performance processor 105 may correlate the performance data, operational data, billing data and the service information. A service provider offers a service to the customer. This service may be a VPN service connecting two of the customer's locations or sites. The service information describes the type of VPN the customer has purchased, such as a Frame Relay VPN service, the subscribed bandwidth such as 256 KB or the type of QoS priority such as Real-Time traffic queue or Best effort traffic only. The network is then provisioned between the two locations or sites by the service provisioning system. During provisioning, a circuit is established from the CPE at one customer location to the service provider PE router interface. Additionally another access circuit may be established between another PE router interface and the other customer site. A VPN service with a VRF is established between the two sites so a complete circuit is then established from one location to the second location. Once the network for the VPN service has been provisioned the network performance data for monitoring the quality of service is then collected. Before the network performance data is analyzed for SLA compliance, the network data must be correlated with the service information. For this the network performance data as collected from the SAAs and the data corresponding to the routers and router interfaces of the CPEs and PE must be associated or tied to the VPN service the customer has purchased. Operational data as obtained in [036] must also be associated with the service and network data. In addition, the billing charges or the monthly recurring charge corresponding to the VPN service must also be obtained from the billing system 170 and associated with the service and network data. Once this relationship has been established, it is then possible to apply the business rules stated in the SLA contract, compute the SLA metrics according to the business rules, determine any SLA violations by comparing the calculated SLA metrics to the thresholds listed in the customer SLA contract and compute the SLA credits,

From stage 420 where performance processor 105 may correlate the performance data and the service information, method 400 may advance to stage 422 where performance processor 105 may analyze the data and compute the service level metrics or KPIs from the network performance data, trouble ticket data and other operational data. The computation of service level metrics may include at least one rule. The at least one rule may include one or both of a service level agreement rule and a contract rule. For example, the at least one rule may be that the network performance data collected during maintenance times may be excluded from being considered for SLA reporting purposes. For example, the network performance data may be packet loss for each of a plurality of class of service, collected at every 5 minute interval over a period of one month. The plurality of the class of service may include best effort, priority business, interactive, and real-time. The performance processor 105 will apply the at least one rule, exclude the data during the maintenance times, for example, between 12 am and 8 am and calculate the average on the remaining data points to obtain the monthly average packet loss service level metric for each of a plurality of class of service.

From stage 422 where performance processor 105 may compute the service level metrics or KPIs, method 400 may advance to stage 425 where performance processor 105 may determine a violation of the at least one rule by the data network. The violation of the at least one rule by the data network may be based on the collected performance data, the calculated service level metrics and the at least one rule. For example, determining the violation of the at least one rule may include using a different threshold for each of a plurality of class of service. The plurality of the class of service may include best effort, priority business, interactive, and real-time. Furthermore, determining the violation of the rule may include calculating a credit to a customer. The calculation of the credit may be based on a percentage of a monthly recurring charge. The monthly recurring charge may be calculated with revenue considerations. The revenue considerations may include a cost of a service to the provider, a revenue projection and a class of service. Once performance processor 105 determines the violation of the at least one rule by the data network in stage 425, method 400 may then end at stage 430.

FIG. 5 is a flow chart setting forth the general stage involved in subroutine 410 consistent with embodiments of the invention. Subroutine 410 may begin at starting block 505 and proceed to stage 510 where performance processor 105 may collect the at least one measurement from the at least one device on the data network. For example, collecting the performance data on the data network may include collecting at least one measurement from at least one device on the data network. Collecting the at least one measurement may include collecting: bandwidth utilization, quality of service, up/down status of devices, latency, delay round trip, delay one way, jitter round trip, jitter one way, packet loss round trip, packet loss one way, and packets out of sequence.

Consistent with embodiments of the invention, event receiver processor 120 receives, through performance measurement processor 105, service failure events (“traps”) generated by shadow router 110 hosting, for example, SAAs. Event receiver processor 120 also receives traps generated by the performance management processor 125 on traffic events (e.g., bandwidth utilization and QoS traffic polices packet drops). In addition, event receiver processor 120 may also receive traps on device or interface failures from other devices on the service provider network and also from direct polling of these devices, for example, for up/down status of the devices and interfaces on the devices. The collected network performance measurement data may comprise, but is not limited to, delay round trip, delay one way, jitter round trip, jitter one way, packet loss round trip, packet loss one way, and packets out of sequence. Moreover, the network performance measurement data may also comprise data relating to at least one of bandwidth utilization on the service provider network, for example on the interface from CPE to the PE, QoS Traffic policer values, and the up/down status of devices on the service provider network.

Collecting the at least one measurement from the at least one device may include collecting the at least one measurement from the at least one device on the data network. The data network may include elements controlled by a plurality of service providers. The at least one measurement may be collected from the at least one device. Also, the at least one device may be on the data network of a second service.

Furthermore, collecting the performance data on the data network may include collecting the performance data measured across any layer 2 access. In addition, collecting the performance data on the data network may include collecting the performance data from a service assurance system. The service assurance system may include a trouble ticket system and a fault management system.

Collecting the performance data may additionally include collecting the performance data from a service assurance system. The performance data may comprise an outage ticket identification and outage restoration time and date, a severity rating, a duration time, and a fault cause. In addition, collecting the performance data on the data network may include collecting performance data from a service fulfillment system. For example, the service fulfillment systems may include a service order system, a customer information system, a provisioning system, and an inventory system. Furthermore, collecting the performance data may include collecting performance data independent of a data type. For example, the data type may include a network performance data type, a procedural performance data type, and an operational performance data type.

From stage 510 where performance processor 105 collects the at least one measurement from the at least one device on the data network, subroutine 410 may advance to stage 515 where performance processor 105 may normalize the collected at least one measurement. For example, normalizing the collected at least one measurement may include compensating the collected at least one measurement for an excused down time, accruing the collected at least one measurement for a period, and determining a period average of the at least one measurement. The excused down time may include down time for planned maintenance, a customer problem, and a force majeure outage.

From stage 515 where performance processor 105 may normalize the collected at least one measurement, subroutine 410 may advance to stage 520 where performance processor 105 may store the normalized at least one measurement. After storing the normalized at least one measurement, subroutine 410 may advance to stage 525 where subroutine 410 may return to stage 415 (FIG. 4).

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing service level agreement management, the method comprising:
collecting performance data on a data network;
collecting service information comprising at least one rule, wherein the at least one rule comprises at least one of the following: a service level agreement rule and a contract rule;
correlating the performance data and the service information; and
determining a violation of the at least one rule by the data network based on the collected performance data and the at least one rule.

2. The method of claim 1, wherein collecting the performance data on the data network comprises collecting at least one measurement from at least one device on the data network.

3. The method of claim 2, wherein collecting the at least one measurement comprises collecting at least one of the following: bandwidth utilization, quality of service, up/down status of devices, latency, delay round trip, delay one way, jitter round trip, jitter one way, packet loss round trip, packet loss one way, and packets out of sequence.

4. The method of claim 2, wherein collecting the at least one measurement from the at least one device on the data network comprises:
collecting the at least one measurement from the at least one device on the data network, wherein the data network comprises elements controlled by a plurality of service providers, wherein the at least one measurement is collected from the at least one device, the at least one device being on the data network of a second service provider;
normalizing the collected at least one measurement, wherein normalizing comprises at least compensating the collected at least one measurement for an excused down time, accruing the collected at least one measurement for a period, and determining a period average of the at least one measurement, wherein the excused down time comprises at least one of the following: a planned maintenance, a customer problem, and a force majeure outage; and
storing the normalized at least one measurement.

5. The method of claim 1, wherein collecting the performance data on the data network comprises collecting the performance data measured across any layer 2 access.

6. The method of claim 1, wherein collecting the performance data on the data network comprises collecting the performance data from a service assurance system comprising at least one of the following: a trouble ticket system and a fault management system.

7. The method of claim 1, wherein the collecting the performance data comprises collecting the performance data from a service assurance system, the performance data comprising at least one of the following: an outage ticket identification, an outage restoration time and date, a severity rating, a duration time, and a fault cause.

8. The method of claim 1, wherein collecting the performance data on the data network comprises collecting the performance data from a service fulfillment system comprising one of the following: a service order system, a customer information system, a provisioning system, and an inventory system.

9. The method of claim 1, wherein collecting the performance data comprises collecting the performance data independent of a data type, wherein the data type comprises one of the following: a network performance data type, a procedural performance data type, and an operational performance data type.

10. The method of claim 1, wherein collecting the service information comprises collecting the service information from a system comprising at least one of the following: a service level agreement catalog system, a customer information system, a billing system, and a service order system.

11. The method of claim 1, wherein determining the violation of the at least one rule comprises determining the violation of the at least one rule using a different threshold for each of a plurality of class of service, wherein the plurality of the class of service comprises at least one of the following: best effort, priority business, interactive, and real-time.

12. The method of claim 1, wherein determining the violation of the rule comprises calculating a credit to a customer based on a percentage of a monthly recurring charge, wherein the monthly recurring charge is calculated with revenue considerations comprising at least on one of the following: a cost of a service to the provider, a revenue projection, a class of service.

13. A system for providing service level agreement management, the system comprising:
a memory storage; and
a processing unit coupled to the memory storage, wherein the processing unit is operative to:
collect performance data on a data network;
collect service information comprising at least one of a customer, a product, and at least one rule, wherein the at least one rule comprises at least one of the following: a service level agreement rule and a contract rule;
correlate the performance data and the service information, wherein the at least one rule and the service information are correlated into a service level template, wherein the service level template provides an association of the customer, the product, the at least one rule; and
determine a violation of the at least one rule by the data network based on the collected performance data and the at least one rule.

14. The system of claim 13, wherein the processing unit is further operative to collect at least one measurement from at least one device on the data network.

15. The system of claim 13, wherein the processing unit is further operative to:
collect the at least one measurement from the at least one device on the data network, wherein the data network comprises elements controlled by a plurality of service providers, wherein the at least one measurement is collected from the at least one device, the at least one device being on the data network of a second service provider;
normalize the collected at least one measurement, wherein normalizing comprises at least compensating the collected at least one measurement for an excused down time, accruing the collected at least one measurement for a period, and determining a period average of the at least one measurement, wherein the excused down time comprises at least one of the following: a planned maintenance, a customer problem, and a force majeure outage; and
store the normalized at least one measurement.

16. The system of claim 13, wherein the processing unit is further operative to calculate a credit to a customer based on a percentage of a monthly recurring charge, wherein the monthly recurring charge is calculated with revenue considerations comprising at least on one of the following: a cost of a service to the provider, a revenue projection, a class of service.

17. A computer-readable medium which stores a set of instructions which when executed performs a method for providing service level agreement management, the method executed by the set of instructions comprising:
collecting performance data on a data network;
collecting service information comprising at least one of a customer, a purchased product, a device, a cost to serve, and at least one rule, wherein the at least one rule comprises at least one of the following: a service level agreement rule and a contract rule;
correlating the performance data and the service information, wherein the service information is correlated into a service model; and
determining a violation of the at least one rule by the data network based on the collected performance data and the at least one rule.

18. The computer-readable medium of claim 17, wherein collecting the performance data on the data network comprises collecting at least one measurement from at least one device on the data network.

19. The computer-readable medium of claim 17, wherein collecting the performance data on the data network comprises collecting the performance data from a service assurance system comprising at least one of the following: a trouble ticket system and a fault management system.

20. The computer-readable medium of claim 17, wherein determining the violation of the at least one rule comprises determining the violation of the at least one rule using a different threshold for each of a plurality of class of service, wherein the plurality of the class of service comprises at least one of the following: best effort, priority business, interactive, and real-time.
